(19) United States
(12) Patent Application Publication
(10) Pub. No.: US 2007/0234840 A1
(43) Pub. Date: Oct. 11, 2007

(54) Push-to-release foot brake with eccentric pawl-and-sector self adjust mechanism

(76) Inventors: Anthony Stephen Ferenc, Goodrich, MI (US); Michael Brian Clements, Macomb, MI (US)

Correspondence Address: Porter, Wright, Morris & Arthur, LLP, 41 South High Street, Columbus, OH, 43215, US

(21) Appl. No.: 11/393,295

(22) Filed: Mar. 30, 2006

(51) Int. Cl. G05G 1/14

(52) U.S. Cl. 74/512

(57) ABSTRACT

A parking brake actuator includes a support bracket, a lever supported by the support bracket and pivotable between a brake-released position and a brake-applied position, a push-to-release lock mechanism operably connecting the lever and the support bracket to selectively lock the lever in the brake-applied position, and a self adjust mechanism having a cable connection and a sector member pivotable relative to the lever, a spring member resiliently biasing the cable connection in one direction, and a pawl secured to the lever and movable between a first position wherein the pawl engages the sector member to prevent pivoting motion of the cable connection relative to the lever and a second position wherein the pawl releases the sector member. The pawl is resiliently biased to the first position and the pawl engages an abutment when the lever is in the brake-released position to move the pawl to the second position.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to foot brakes for motor vehicles and, more particularly, push-to-release foot brakes for motor vehicles that have self adjust mechanisms.

### BACKGROUND OF THE INVENTION

Motor vehicles are typically provided with park or “emergency” brakes that are operated by a cable. The cable extends from the brake mechanism to an actuator within the passenger compartment of the vehicle and convenient to the driver. The actuator is operated to tension and release the cable to apply and release the parking brake mechanism. The actuator can be a foot lever or pedal for foot operation or a hand lever for hand operation. A lock mechanism is provided to retain the lever in the brake-apply position and a release is provided to selectively disengage the lock so that the lever returns to a brake-unapplied position. For pedals, the release has been in the form of a release handle that disengages the lock or a push-to-release mechanism that disengage the lock with foot operation of the pedal. For example, see U.S. Pat. Nos. 5,217,094 and 5,775,174, the disclosures of which are expressly incorporated herein in their entireties by reference.

It has been found that these cables can stretch with use. To adjust for this stretching, various take-up or self-adjust mechanisms have been utilized. The self-adjust mechanisms automatically remove slack from the cable when the brake lever is in its brake-unapplied position. For example, see U.S. Pat. Nos. 5,211,072, 5,546,828, and 6,282,980, the disclosures of which are expressly incorporated herein in their entireties by reference.

Initial operation of the lever requires a relatively low input force as slack is taken up and the cable is initially tensioned. Further tensioning, however, requires increasing input force. To adjust for this variance, variable ratio arrangements have been utilized so that the amount of cable travel per unit of lever travel decreases as the brake is applied. For example, see U.S. Pat. Nos. 5,211,072, 5,546,828, and 6,282,980, the disclosures of which are expressly incorporated herein in their entireties by reference.

While various prior parking brake actuators incorporating some of these features have been proposed, they have not provided all of the desired features in a manner that is relatively inexpensive to produce, relatively easy to operate, and reliable over time. There is a never ending desire in the motor vehicle industry to reduce cost, weight and package space without adversely affecting performance. There is also a never ending desire to provide more feature rich products. Accordingly, there is a need in the art for an improved parking brake actuator for a motor vehicle.

### SUMMARY OF THE INVENTION

The present invention provides an improved parking brake actuator which overcomes at least some of the above-noted problems of the related art. According to the present invention, a parking brake actuator comprises, in combination, a support bracket, a lever supported by the support bracket and pivotable between a brake-released position and a brake-applied position, a push-to-release lock mechanism operably connecting the lever and the support bracket to selectively lock the lever in the brake-applied position, and a self adjust mechanism having a cable connection and a sector member pivotable relative to the lever, a spring member resiliently biasing the cable connection and the sector member in one direction, and a pawl movably secured to the lever and movable between a first position wherein the pawl engages the sector member to prevent pivoting motion of the cable connection relative to the lever and a second position wherein the pawl releases the sector member to permit pivoting motion of the cable connection relative to the lever. The pawl is resiliently biased to the first position and the pawl engages an abutment when the lever is in the brake-released position to move the pawl to the second position.

According to another aspect of the present invention, a parking brake actuator comprises, in combination, a support bracket, a lever supported by the support bracket and pivotable between a brake-released position and a brake-applied position, and a push-to-release lock mechanism operably connecting the lever and the support bracket to selectively lock the lever in the brake-applied position. The push-to-release lock mechanism includes a sector gear having a plurality of ratchet teeth and a lock pawl having a hook selectively engageable with the ratchet teeth to lock the lever in the brake-applied position. The actuator also includes a self adjust mechanism having a cable connection and a sector member pivotable relative to the lever, a spring member resiliently biasing the cable connection and the sector member in one direction, and an adjust pawl movably secured to the lever and movable between a first position wherein the adjust pawl engages the sector member to prevent pivoting motion of the cable connection relative to the lever and a second position wherein the pawl releases the sector member to permit pivoting motion of the cable connection relative to the lever. The adjust pawl is resiliently biased to the first position and the adjust pawl engages an abutment when the lever is in the brake-released position to move the adjust pawl to the second position.

According to yet another aspect of the present invention, a parking brake actuator comprises, in combination, a support bracket, a pedal supported by the support bracket and pivotable between a brake-released position and a brake-applied position, and a push-to-release lock mechanism operably connecting the pedal and the support bracket to selectively lock the pedal in the brake-applied position. The push-to-release lock mechanism includes a sector gear having a plurality of ratchet teeth and a lock pawl having a hook selectively engageable with the ratchet teeth to lock the pedal in the brake-applied position. The sector gear is rigidly secured to the lever and the lock pawl is movably secured to the support bracket by a connection pin extending through a slot in the lock pawl. The lock pawl is biased relative to the sector member by a torsion spring and movement of the lock pawl changes a force vector of the torsion spring to selectively bias the lock pawl in opposed directions relative to sector gear. The connection pin is at one end of the slot and the torsion spring biases the pawl toward engagement with the sector member when the pedal is in the brake-released position and the connection pin is at the other end of the slot and the torsion spring biases the lock pawl away from engagement with the sector gear when the pedal is in the brake-applied position. The actuator also includes a self adjust mechanism having a cable connection and a sector member pivotable relative to the lever, a spring member resiliently biasing the cable connection and the sector member in one direction, and an adjust pawl movably secured to the pedal and movable between a first position wherein the pawl engages the sector member to prevent pivoting motion of the cable connection relative to the pedal and a second position wherein the adjust pawl releases the sector member to permit pivoting motion of the cable connection relative to the pedal. The adjust pawl is resiliently biased to the first position and the adjust pawl engages an abutment when the pedal is in the brake-released position to move the adjust pawl to the second position.

From the foregoing disclosure and the following more detailed description of various preferred embodiments it will be apparent to those skilled in the art that the present invention provides a significant advance in the technology and art of motor vehicle parking brake actuators. Particularly significant in this regard is the potential the invention affords for providing a high quality, reliable, low cost parking brake actuator having reduced package size and desired operating features. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is an exploded perspective view of a parking brake actuator according to a preferred embodiment of the present invention;

FIG. 2 is a side elevation view of components of a push-to-release lock mechanism of the parking brake actuator of FIG. 1, wherein the lock mechanism is in a brake-release position various components are removed for clarity;

FIG. 3 is a side elevation view of the components of the push-to-release lock mechanism similar to FIG. 2, but wherein the lock mechanism is in a brake-applied position;

FIG. 4 is a fragmented elevational view of a self adjust mechanism the parking brake actuator of FIG. 1, wherein various components re removed for clarity; and

FIG. 5 is a schematic view of the parking brake actuator of FIG. 1.

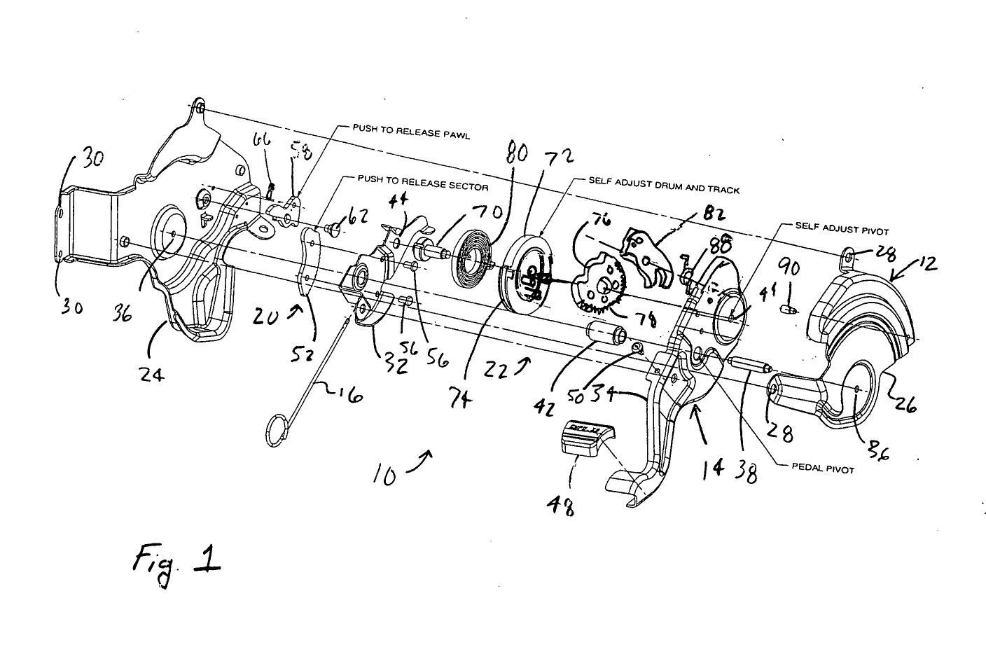

It should be understood that the appended drawings are not necessarily to scale, presenting a somewhat simplified representation of various preferred features illustrative of the basic principles of the invention. The specific design features of the parking brake actuator as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the parking brake actuator illustrated in the drawings. In general, up or upward generally refers to an upward direction within the plane of the paper in FIG. 1 and down or downward generally refers to a downward direction within the plane of the paper in FIG. 1. Also in general, fore or forward refers to a direction toward the front of the motor vehicle, that is, generally toward the right in FIG. 1 and aft or rearward refers to a direction toward the rear of the motor vehicle, that is, generally toward the left in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved parking brake actuators disclosed herein. The following detailed discussion of various alternative and preferred embodiments will illustrate the general principles of the invention with reference to a foot operated parking brake actuator for a motor vehicle such as an automobile, sport utility vehicle (SUV), crossover vehicle, or the like. Other embodiments suitable for other applications will be apparent to those skilled in the art given the benefit of this disclosure.

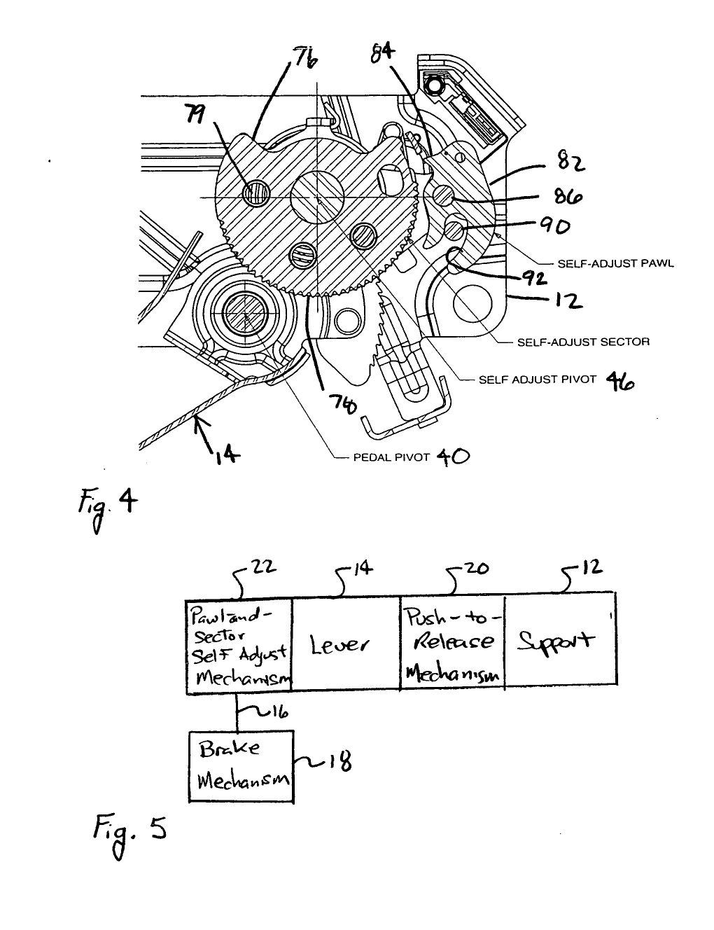

Referring now to the drawings, FIGS. 1 to 5 show a push-to release parking brake actuator 10 according to a preferred embodiment of the present invention. The illustrated parking brake actuator 10 includes a mounting or support bracket 12, a lever or pedal 14 supported by the support bracket 12 and pivotable between a brake-released position and a brake-applied position, a control cable 16 operably connecting the pedal 14 and tensioned and untensioned by the pivoting motion of the pedal 14 to apply and release a wheel brake mechanism 18, a push-to-release lock mechanism 20 for selectively securing the pedal 14 in its brake-applied position, and a pawl-and-sector self adjust mechanism 22 for automatically taking-up slack, that is, applying a predetermined slack tension in the control cable 16 when the pedal 14 is in its brake-released position.

The illustrated support bracket 12 is a two-part bracket having left and right bracket components 24, 26 secured together and supporting the pedal 14 therebetween. Suitable openings 28 are provided for accommodating fasteners to secure the bracket components 24, 26 together. The support bracket 12 is also provided with suitable openings 30 for accommodating fasteners to secure the support bracket 12 to a support structure adjacent the driver's position in the motor vehicle.

The illustrated pedal 14 is a two-part pedal having left and right pedal components 32, 34 secured together and supporting the self adjust mechanism 22 therebetween. The pedal components 32, 34 are provided with aligned openings 36 for an axle 38 that pivotably supports the pedal 14. The axle 38 is supported by and extends between the bracket components 24, 26 to define a horizontal and laterally extending pivot axis 40 for the pedal 14. The illustrated axle 38 has a spacer or bushing 42 provided thereabout that defines a lateral spacing between the pedal components 32, 34 and between the bracket components 24, 26. Another pair of aligned openings 44 is provided at an upper end of the pedal components 32, 34, above the axle 38, for the self adjust mechanism 22 as described in more detail hereinafter. The aligned openings 44 define a horizontal and laterally extending pivot axis 46 for the self adjust mechanism 22 that is parallel and spaced apart from the pedal pivot axis 40. A pedal pad 48 is provided at a lower end of the pedal 14, below the axle 38, for engagement by the driver's foot to operate the parking brake actuator 10 as described in more detail hereinbelow.

The control cable 16 is connected to the pedal 12 via the self adjust mechanism 22. The other end of the control cable 16 is operably connected to the wheel brake mechanism 18. When the driver depressed the pedal pad 48 to pivot the pedal 14 in the counterclockwise direction (as shown in FIG. 1) to the brake-applied position, the control cable 16 is tensioned to activate or set the wheel brake mechanism 18. The pedal 14 is urged to rotate in the clockwise direction (as shown in FIG. 1) to the brake-released position by a return spring and/or the brake mechanism 18 to untension the control cable 16 and deactivate or release the wheel brake mechanism 18. Rotation of the pedal 14 in the clockwise direction is restricted by engagement of a stop 50 against an abutment of the support bracket 12. The illustrated stop 50 is located between the axle 38 and the pedal pad 48.

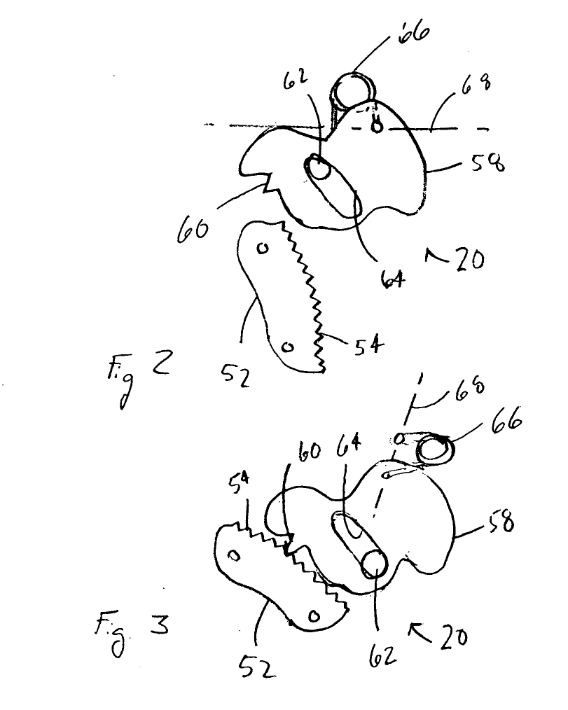

The illustrated push-to-release lock mechanism 20 includes a sector member 52 having a plurality of ratchet teeth 54 secured to the pedal 14 for pivotable movement therewith. The illustrated sector member 52 is secured to the left pedal component by a pair of rivets 56. A pawl 58 having a hook or engagement tooth 60 that is selectively engageable with the ratchet teeth 54 is rotatatably supported by the left bracket component 24 about a connection pin 62. The ratchet teeth 54 and the pawl 58 are sized and shaped to engage one another and hold the wheel brake mechanism 18 at a position achieved when the pedal 14 is depressed to activate the wheel brake mechanism 18. The illustrated ratchet teeth 54 are formed along a circular arc disposed about the pedal pivot axis 40. The pawl 58 is able to be turned between a first or released position wherein the hook 60 of the pawl 58 is released from the ratchet teeth 54 of the sector member 52 (shown in FIG. 2) and a second or locking position wherein the hook 60 of the pawl 58 is engaged with the ratchet teeth 54 of the sector member 52 (shown in FIG. 3).

The pawl 58 is provided with an elongated hole or slot 64 for passage of the connection pin 62 that is elongated in the direction of rotation of the pedal 14. The slot 64 enables the pawl 58 to be slideably moved between the first and second positions. A torsion spring 66 extends between the left bracket component 24 and the pawl 58 to urge the pawl 58 in different directions. The torsion spring 66 has a first end connected to a hole in the pawl 58 and a second end connect to an end in the left bracket component 24. As the pawl 58 shifts along the slot 64, a force vector 68 of the torsion spring 66 rotates in different ways. In the first position, the spring force vector 68 biases the pawl 58 toward the sector member 52 while in the second position the force vector 68 biases the pawl 58 away from the sector member 52.

When pedal 14 is in the brake-release position and the driver pushes the pedal 14 to active the wheel brake mechanism 18, the pedal 14 rotates about the pivot axis 40 to tension the control cable 16 and activate the brake mechanism 18. The pedal 14 also rotates the sector member ratchet teeth 54 along the pawl hook 60 in a ratchet like manner as the torsion spring 66 urges the pawl hook 60 into engagement with the ratchet teeth 54. When the driver releases the pedal 14, the pawl 58 shifts so that the connection pin 62 is at the other end of the slot 64 by the reaction force transmitted to the pedal 54 from the wheel brake mechanism 18 through the control cable 16. When the pawl 58 moves, the orientation or posture of the torsion spring 66 is changed so that its force vector 58 is biasing the pawl 58 away from the sector member 52. When the driver desires to release or deactivate the wheel brake mechanism 18, the driver pushes or depresses the pedal 14 a second time and the torsion spring 66 forces the pawl 58 away from the ratchet teeth 54 as the pedal pivots to release the pedal 54. When the driver releases the pedal pad 48, the return spring and/or brake mechanism 18 moves the pedal 14 back to its release position and the pedal 14 moves the pawl 58 back to its first or release position. The pawl 58, the pedal 14, and the support bracket 12 are constructed and arranged to move the pawl 58 in this desired manner.

The illustrated pawl-and sector self adjust mechanism 22 is a rotary-type assembly and includes an axle 70 that extends between the openings 44 and is supported by the pedal components 32, 34. The longitudinal axis of the axle 70 defines the pivot axis 46 of the self-adjust mechanism 22 and is substantially parallel to and spaced apart from the pedal pivot axis 40. The pivot axis 46 is preferably a distance from the pedal pivot axis 40 substantially equal to the distance between the pedal pivot axis 40 and the pawl connection pin 62 of the lock mechanism 20. The self adjust mechanism 22 includes a drum and track member 72 that is rotatably supported by the axle 70. The drum and track member 72 includes a cable connection 74 which is movable in opposite directions within an arcuate path about the pivot axis 46. The cable connection 74 is constructed and arranged to fixedly connect with one end of the control cable 16 so that when the cable connection 74 moves in the arcuate path in one direction, the control cable 16 connected thereto will be moved in a direction to increase the tension in the control cable 16 and when moved in the opposite direction, the control cable will be moved in a direction to untension or slacken the tension therein.

The self adjust mechanism 22 also includes a sector member 76 having a plurality of teeth 78. The teeth 78 are in an arcuate row about the pivot axis 46. The illustrated sector member 76 is secured to the drum and track member 72 for pivoting motion therewith in opposite directions in conjunction with movement of the cable connection 74. The illustrated drum and track member has a plurality of pins 79 that extend into opening of the sector member 76 to secure them for rotation together. A spring member 80 acts on the drum and track member 72 to resiliently bias the cable connection 74 to move within its arcuate path in the first direction to apply a predetermined tension in the control cable 16 and resiliently bias the sector member 76 in the same direction. The illustrated spring member 80 is a spiral spring located between the drum and track member 72 and the left pedal component 32. The spring member 80 has a first end operably engaging a slot in the axle 70 and a second end operably engaging a slot in the drum and track member 72 to bias the drum and track member 72 relative to the stationary axle 70.

The self adjust mechanism 22 also includes a pivotable pawl 82 having a tooth or hook 84. The illustrated pawl 82 is pivotably secured to the pedal 14 about a pin 86. The pawl 82 constructed and arranged so that the tooth 84 selectively engages the teeth 78 of the sector member 76 to prevent movement of the sector member 76 relative the pedal 14. A spring member 88 biases the pawl 82 into engagement with the sector member 76. A first end of the illustrated spring member 88 extends into an opening in the pawl 82 while a second end of the spring member 88 extends into an opening in the pedal 14. It is noted that the lock spring first end can alternatively be secured in other suitable manners. An abutment 90 is provided on the support bracket 12 that is constructed and arranged to operably engage the pawl 82 when the pedal 14 is in it brake-release position. The illustrated abutment 90 is formed by a pin extending between the left and right bracket components 24, 26. Upon engagement with the abutment 90, the pawl 82 moves from its normal locking position wherein the pawl 82 is engaging the sector member 76 to secure the sector member 76 to the pedal 14 to a disengaged position wherein the pawl 82 is disengaged from the sector member 76 to allow the sector member 76 to move in opposite directions about the axle 70 with the drum and track member 72 and the cable connection 74. The illustrated pawl 82 is provided with an arcuate slot 92 constructed and arranged to form camming surfaces for moving and holding the pawl 82 out of engagement with the sector member 76 when the pedal 14 is in its brake release position.

When the pedal 14 is in its brake-released position, the abutment 90 maintains the pawl 82 in its disengaged position to allow the drum and track member 72, the cable connection 74, and the sector member 76 to move relative to the pedal 14. The spring member 80 is thus free to automatically bias the drum and track member 72, the cable connection 74, and the sector member 76 to maintain the predetermined slack tension in the control cable 16. Thus, the self adjust mechanism 22 automatically compensates for control cable stretch and the like. When the pedal 14 moves out of its brake-released position, the pawl 82 moves away from the abutment 90 and resiliently snaps back to its normal locking position to secure the pawl 82 against the sector member 76 and frictionally prevent the drum and track member 72, the cable connection 74, and the sector member 76 from moving relative to the pedal 14.

The pivot axis 46 of the illustrated self-adjust mechanism 22 is spaced from the pedal pivot axis 40. By providing this eccentric positioning of the cable connection 74, the parking brake actuator 10 achieves a variable mechanical advantage as the pedal 14 is stroked. Thus, the amount of operator input force necessary to apply the wheel brake mechanism 18 throughout the pedal stroke is reduced.

It is apparent from the above detailed description of preferred embodiments of the present invention, that the parking brake actuator 10 provides reduced stress on components because there is not a high fly back upon release of the lock mechanism 20 which causes high impact forces. The parking brake actuator 10 also provides a simplified, direct design with fewer parts than the prior art.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A parking brake actuator comprising, in combination:
a support bracket;
a lever supported by the support bracket and pivotable between a brake-released position and a brake-applied position;
a push-to-release lock mechanism operably connecting the lever and the support bracket to selectively lock the lever in the brake-applied position;
a self adjust mechanism having a cable connection and a sector member pivotable relative to the lever, a spring member resiliently biasing the cable connection and the sector member in one direction, and a pawl movably secured to the lever and movable between a first position wherein the pawl engages the sector member to prevent pivoting motion of the cable connection relative to the lever and a second position wherein the pawl releases the sector member to permit pivoting motion of the cable connection relative to the lever; and
wherein the pawl is resiliently biased to the first position and the pawl engages an abutment when the lever is in the brake-released position to move the pawl to the second position.

2. The parking brake actuator according to claim 1, wherein the lever is a foot pedal.

3. The parking brake actuator according to claim 1, wherein a control cable is operably connected to the cable connection.

4. The parking brake actuator according to claim 1, wherein the push-to-release lock mechanism includes a sector gear having a plurality of ratchet teeth and a lock pawl having a hook selectively engageable with the ratchet teeth to lock the lever in the brake-applied position.

5. The parking brake actuator according to claim 4, wherein the sector gear is rigidly secured to the lever and the lock pawl is movably secured to the support bracket.

6. The parking brake actuator according to claim 4, wherein the lock pawl is movably secured to the support bracket by a connection pin extending through a slot in the lock pawl.

7. The parking brake actuator according to claim 6, wherein the lock pawl is biased relative to the sector gear by a torsion spring.

8. The parking brake actuator according to claim 7, wherein movement of the lock pawl changes a force vector of the torsion spring to selectively bias the lock pawl in opposed directions relative to sector gear.

9. The parking brake actuator according to claim 8, wherein the connection pin moves along the slot to change the force vector of the torsion spring.

10. The parking brake actuator according to claim 9, wherein the connection pin is at one end of the slot and the torsion spring biases the lock pawl toward engagement with the sector gear when the lever is in the brake-released position and the connection pin is at the other end of the slot and the torsion spring biases the lock pawl away from engagement with the sector gear when the lever is in the brake-applied position.

11. A parking brake actuator comprising, in combination:
a support bracket;
a lever supported by the support bracket and pivotable between a brake-released position and a brake-applied position;
a push-to-release lock mechanism operably connecting the lever and the support bracket to selectively lock the lever in the brake-applied position;
wherein the push-to-release lock mechanism includes a sector gear having a plurality of ratchet teeth and a lock pawl having a hook selectively engageable with the ratchet teeth to lock the lever in the brake-applied position;
a self adjust mechanism having a cable connection and a sector member pivotable relative to the lever, a spring member resiliently biasing the cable connection and the sector member in one direction, and an adjust pawl movably secured to the lever and movable between a first position wherein the adjust pawl engages the sector member to prevent pivoting motion of the cable connection relative to the lever and a second position wherein the pawl releases the sector member to permit pivoting motion of the cable connection relative to the lever; and
wherein the adjust pawl is resiliently biased to the first position and the adjust pawl engages an abutment when the lever is in the brake-released position to move the adjust pawl to the second position.

12. The parking brake actuator according to claim 11, wherein the lever is a foot pedal.

13. The parking brake actuator according to claim 11, wherein a control cable is operably connected to the cable connection.

14. The parking brake actuator according to claim 11, wherein the sector gear is rigidly secured to the lever and the lock pawl is movably secured to the support bracket.

15. The parking brake actuator according to claim 11, wherein the lock pawl is movably secured to the support bracket by a connection pin extending through a slot in the lock pawl.

16. The parking brake actuator according to claim 15, wherein the lock pawl is biased relative to the sector gear by a torsion spring.

17. The parking brake actuator according to claim 16, wherein movement of the lock pawl changes a force vector of the torsion spring to selectively bias the lock pawl in opposed directions relative to sector gear.

18. The parking brake actuator according to claim 17, wherein the connection pin moves along the slot to change the force vector of the torsion spring.

19. The parking brake actuator according to claim 18, wherein the connection pin is at one end of the slot and the torsion spring biases the lock pawl toward engagement with the sector gear when the lever is in the brake-released position and the connection pin is at the other end of the slot and the torsion spring biases the lock pawl away from engagement with the sector gear when the lever is in the brake-applied position.

20. A parking brake actuator comprising, in combination:
a support bracket;
a pedal supported by the support bracket and pivotable between a brake-released position and a brake-applied position;
a push-to-release lock mechanism operably connecting the pedal and the support bracket to selectively lock the pedal in the brake-applied position;
wherein the push-to-release lock mechanism includes a sector gear having a plurality of ratchet teeth and a lock pawl having a hook selectively engageable with the ratchet teeth to lock the pedal in the brake-applied position;
wherein the sector gear is rigidly secured to the lever and the lock pawl is movably secured to the support bracket by a connection pin extending through a slot in the lock pawl;
wherein the lock pawl is biased relative to the sector member by a torsion spring and movement of the lock pawl changes a force vector of the torsion spring to selectively bias the lock pawl in opposed directions relative to sector gear;
wherein the connection pin is at one end of the slot and the torsion spring biases the pawl toward engagement with the sector member when the pedal is in the brake-released position and the connection pin is at the other end of the slot and the torsion spring biases the lock pawl away from engagement with the sector gear when the pedal is in the brake-applied position;
a self adjust mechanism having a cable connection and a sector member pivotable relative to the lever, a spring member resiliently biasing the cable connection and the sector member in one direction, and an adjust pawl movably secured to the pedal and movable between a first position wherein the pawl engages the sector member to prevent pivoting motion of the cable connection relative to the pedal and a second position wherein the adjust pawl releases the sector member to permit pivoting motion of the cable connection relative to the pedal; and
wherein the adjust pawl is resiliently biased to the first position and the adjust pawl engages an abutment when the pedal is in the brake-released position to move the adjust pawl to the second position.
